(19) United States
(12) Patent Application Publication
(10) Pub. No.: US 2009/0243379 A1
(43) Pub. Date: Oct. 1, 2009

(54) Rear Axle Module with Multiple Modulators

(75) Inventors: Naman A. ELAMIN, Avon Lake, OH (US); David W. Howell, Macungie, PA (US); Allen Z. Mikolcic, Bay Village, OH (US)

Correspondence Address: CROWELL & MORING LLP;INTELLECTUAL PROPERTY GROUP, P.O. BOX 14300, WASHINGTON, DC, 20044-4300, US

(73) Assignee: Bendix Spicer Foundation Brake LLC, Elyria, OH (US)

(21) Appl. No.: 12/060,721

(22) Filed: Apr. 1, 2008

(51) Int. Cl. B60T 8/38

(52) U.S. Cl. 303/113.2

(57) ABSTRACT

An anti lock braking system for commercial vehicles is described. The system includes a rear axle brake assembly having a rear brake for each rear wheel, a relay valve for controlling rear axle brakes and a plurality of pressure modulator valves operatively connected to the relay valve, each having an outlet connected to one of the rear brakes. Multiple connector cartridges are used to sealingly connect the relay valve to each of the pressure modulator valves. The connector cartridges have a first end defining a non rotation-dependent fitting, such as a cartridge fitting, cooperating with a corresponding port cavity to form the sealed connection.

### BACKGROUND OF THE INVENTION

The present invention relates to braking systems and methods for commercial vehicles, and in particular to a rear axle brake modulator system utilizing cartridge-style connectors to form an integrated module that is easy to assemble.

### SUMMARY OF THE INVENTION

Commercial vehicles and other large trucks typically pose difficult challenges when it is necessary to stop them. Because of their large mass, these vehicles require large braking forces to slow them, and reductions in the friction between the tires and the road surface can cause serious safety problems because of increased stopping distance and loss of control. As a result, there has been a widespread adoption of anti lock braking systems (ABS) for commercial vehicles. By modulating the fluidic pressure applied to the brakes of the commercial vehicle (typically a pneumatic pressure), the ABS system prevents the wheels from locking up, thus preventing the ensuing decrease in the friction coefficient of the tire with the pavement. The wheels continue rotating at an incipient lockup condition, so that a maximum braking force can be applied, and at the same time helping to maintain directional control and prevent skidding.

Loss of traction on low friction surfaces is problematic for commercial vehicles not only during braking, but also during acceleration, when the uneven application of accelerating force to different wheels can result in loss of control, for example while accelerating in curves. Components of the ABS system may be successfully used to counteract this loss of traction. The Automatic Traction Control (ATC) system by Bendix Commercial Vehicle Systems of Elyria, Ohio, is one example of a system that improves vehicle traction during acceleration and lateral stability while driving through curves by using differential braking, where individual wheel brake applications are used to improve traction.

Another problem faced by commercial vehicles is the loss of control and possible jackknifing, especially of a towing vehicle with a trailer, on various surfaces during maneuvering of the vehicle. This can occur both on low friction surfaces such as snow and rain, and on higher friction surfaces such as dry asphalt and concrete. The Electronic Stability Program (ESP) functionality developed by Bendix Commercial Vehicle Systems, for example, provides the ability to apply brakes to individual wheel ends, among other actions, to counteract the forces that may lead to loss of control.

To fully take advantage of many of the advanced braking options described, such as ESP and ATC, it is preferable to be able to individually control the application of the brake on each wheel. This may require additional components to be used in the braking system than are normally provided, to achieve precise control of each wheel.

The embodiments of the present invention provide a system and apparatus that facilitates the control of individual wheels, so that advanced braking, traction control and electronic stability functionalities may be implemented. According to the present invention, the additional control is achieved while avoiding duplication of many components, and offers the additional benefits of lower cost of manufacturing, space savings on the vehicle due to a smaller ABS package, and a more modular unitary construction, which is easy to assemble.

A typical anti lock braking system such as the Bendix® (ABS includes several components. Wheel speed sensors are installed near each wheel, and together with an exciter ring mounted on the wheel are used to sense wheel speed changes. An Electronic Control Unit (ECU) receives the signals from the wheel speed sensors to monitor how fast each wheel is turning. A Pressure Modulator Valve (PMV) uses solenoids to provide the ability to apply, hold and release the pneumatic pressure being delivered to the brake, and thus to optimize braking performance. An example of a PMV is the Bendix® M-32QR, which may be used to modulate the air pressure reaching an individual wheel or an axle. Depending on the type of ECU used and the vehicle configuration, four, five or more of the PMV units may be used in an installation.

Another component of advanced ABS systems is the Antilock Traction Relay Valve, an example of which is the Bendix® ATR-6. The relay valve provides for both the service braking and the differential braking functions necessary for traction control.

Antilock traction relay (ATR) valves are typically located near the service brakes that they serve. These valves are in fluid communication with the PMV valve, which is located between the relay valve and the actual brake units. According to the present invention, the PMV units are mounted directly on the antilock traction relay valve, to form a modular and compact unit, which may be mounted directly on a rear axle assembly of the commercial vehicle. Although the antilock traction relay valve is necessary to implement certain functions of the ABS system, such as, for example, the ESP functionality, more basic installations lacking those advanced features may only require a simpler relay valve to provide compressed air to the rear axle or axles of the commercial vehicle. Thus, the present invention contemplates the use of ATR or other relay valves, as will be understood by those of skill in the art.

As indicated above, many ABS installations can benefit from having direct control over the braking of each individual wheel of the vehicle. However, due to the cost and complexity of providing that control, conventional installations often use only enough PMV units to control the braking on a rear axle. Accordingly, the capabilities of the ABS system may be reduced.

To provide better control of the braking, separate PMV units are used on each wheel, so that the braking force can be individually modulated. For vehicles with two or more rear axles this is problematic, because in conventional installations, the relay valve can only support a limited number of modulators mounted directly thereto, to form a unitary, integrated assembly. Adding additional modulators requires a second relay valve or the addition of cumbersome and expensive piping. For example, additional modulators can be remotely mounted and connected to the relay valve using tubing. However, it may be difficult to find suitable mounting locations for the remote devices.

The exemplary embodiments of the present invention provide an ABS system where the relay valve for the rear axle of a commercial vehicle is capable of supporting multiple PMV units without additional plumbing. The invention also provides for a simple method of assembly of the PMV units on the relay valve, which also saves space.

Conventional ABS installations include rear axle modules that utilize National Pipe Thread (NPT) fittings or a bolt-on approach to connect the modulator (PMV) to the relay valve, which typically has two ports per side. These types of connections severely limit the ability to attach additional modulators to each side of a single relay valve, because of the limited space available. NPT and bolt-on fittings often require free space around the components being connected to the relay valve, to secure the threaded or other conventional connectors. However, after one modulator is attached to one side of the relay valve, there is insufficient room adjacent to the modulator on that side to place another modulator, and rotate or otherwise secure the connecting portions to form a tight connection. This is due to the small space between the two adjacent modulators necessary to obtain an integrated braking assembly, and the limited distance between ports of the relay valve. It is therefore impossible to connect more than two (one per side) modulators to a single relay valve, without additional remote mount plumbing leading to larger size, a complete redesign of the relay valve, or using multiple relay valves.

The present invention provides the ability to connect multiple PMV units to a relay valve by simplifying the method of connection therebetween. In one exemplary embodiment, the connection is made with elements that do not require rotation to form a sealed connection, unlike the conventional NPT or other threaded connectors. By using connectors that do not require rotation to install and fasten, also referred to as non-rotation-dependent connectors, it is possible to very easily attach multiple modulators in the limited space surrounding the relay valve.

In one exemplary embodiment, the non rotation-dependent connectors include cartridge fittings, which form a sealed connection simply by being pushed into the port cavities of the relay valve and the modulator. According to the invention, the modulator bodies and/or the relay valve body include port cavities to effectuate the connection, instead of the conventional NPT threaded ports. For example, a connector cartridge may be provided with cartridge fittings at one or both ends, and at least one O-ring seal per fitting to allow the parts to be pushed in place instead of rotated, to achieve the proper seal and spacing with ease.

The connector cartridge may include a cartridge fitting adapted to form the sealed connection with a port cavity formed in either the relay valve or the PMV unit. The connector cartridge may also include a conventional fitting or a second cartridge fitting at the other end.

For example, only one of the PMV unit and relay valve being connected may be fitted with a port cavity adapted to receive a cartridge fitting, while the other one may use a conventional threaded fitting. In this embodiment, the corresponding connector cartridge also would have a conventional threaded fitting at one end and a non-rotation-dependent cartridge fitting on the other end. In this case, the threaded fitting of the connector cartridge may be connected first to the appropriate component, for example the PMV, when sufficient space is still available to rotate the connector. Then the connector cartridge would be connected to the other component (for example the relay valve) using the cartridge connection, when there is insufficient space for tightening the threaded connector due to the proximity to the adjacent relay—PMV assembly. This embodiment may also use one or more O-ring seals to prevent leaks.

The exemplary relay valve with four modulators according to the invention is well suited for use in tandem rear and/or 6×4 commercial vehicle applications using ESP systems, since both rear axles provide traction and benefit from traction control and other advanced ABS functionalities. However, other installations may also benefit form the advantages of the invention. The braking module according to the invention is easy to assemble because of the press-in feature of the cartridge fitting, and is more compact than alternative solutions, leaving more free room in the vehicle. Assembly of the brake unit is simplified, and there is a reduced need to customize the installation of components on different vehicle layouts, because a single mounting location is sufficient for the integrated braking apparatus.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view of an ABS assembly according to an embodiment of the invention, having a relay valve and four modulators;

FIG. 2a shows a connector cartridge according to an embodiment of the invention;

FIG. 2b shows a connector cartridge with one conventional fitting, according to another embodiment of the invention; and

FIG. 3 is a perspective view of a different embodiment of an ABS assembly according to the invention, having a relay valve and four modulators.

### DETAILED DESCRIPTION OF THE DRAWINGS

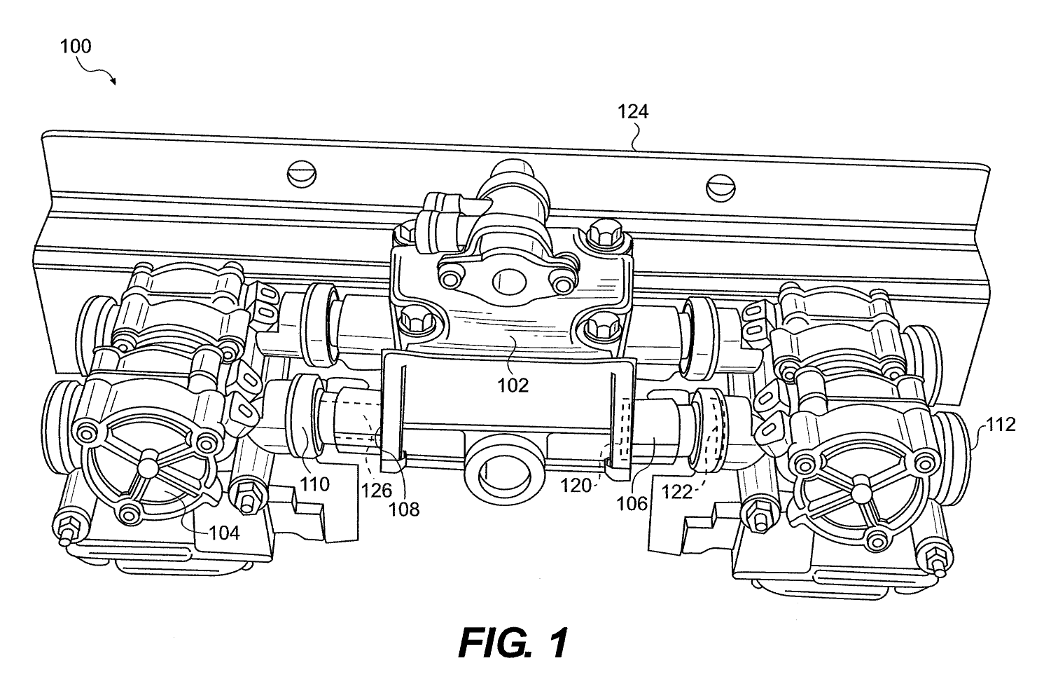

An exemplary embodiment of the ABS rear axle assembly according to the invention is shown in FIG. 1. The rear axle assembly 100 forms a compact and modular component which can be easily manufactured and assembled for mounting on or near the two rear axles of a commercial vehicle. Only one mounting location on the vehicle is necessary, as opposed to the multiple locations required by remote mounting configurations.

The ABS rear axle assembly 100 includes an antilock traction relay valve (ATR) 102, which, for example, may be a Bendix® ATR-6 with four outlet ports 108. The four outlet ports 108 are each connected to an anti lock modulator (or PMV) 104, thus providing a PMV 104 for each of the four wheels or dual wheels (not shown) serviced by the ABS rear axle assembly 100. Each PMV 104 may be, for example, a Bendix® M-32QR unit, with an inlet 110 for connection to the relay valve 102 and an outlet 112 connectable to the brake assembly of a corresponding wheel.

In one exemplary embodiment, the four PMV 104 units are connected to the ATR 102 using a connector cartridge 106. The connector cartridge 106 has a body defining a fluid passage 126 allowing passage of compressed air between the components. One or more sealing elements such as O-rings 120, 122 may be used to prevent leaks from the connections. In the exemplary embodiment, both ends of the connector cartridge 106 are formed as cartridge fittings providing the greatest ease of assembly. However, as discussed above, one end of the connector cartridge may be formed as a conventional threaded fitting, to use with conventional components while still retaining an advantage according to the invention.

The inlets 110 of the PMV 104 units in the exemplary embodiment may be formed as port cavities compatible with the rotation-free cartridge fittings, instead of threaded ports. Similarly, the outlets 108 of the relay valve 102 may be formed as port cavities. The modifications needed to obtain a connection according to the invention are easily incorporated in conventional components with threaded ports, and thus can be applied to relay valves and pressure modulators already in production, without having to re-design their internal working components. To connect the components, it is sufficient to insert the cartridge fitting end of the connection cartridge 106 into the port cavity of one of the elements, and then press the other element onto the free end of the connection cartridge 106. This connection is completed without any twisting or rotation, and without necessitating a large clearance around the components, to permit tightening of the fasteners.

According to embodiment of the invention, the integrated ABS rear axle assembly 100 may be mounted on or near the rear axles, because of the reduced space taken up by the assembly. A mounting bracket 124 may be provided to securely hold the relay valve 102 and the four PMV 104's in place during operation of the commercial vehicle.

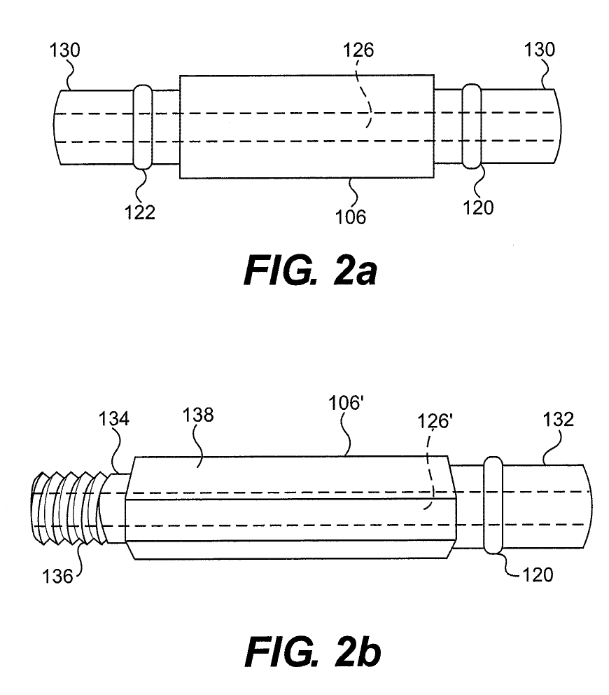

According to an exemplary embodiment of the invention, a connector cartridge 106 is shown in FIG. 2a. The connector cartridge 106 includes an elongated body defining a fluid passage 126 extending therethrough. Cartridge fittings 130 are formed at both ends of the connector cartridge 106, so that they may be easily inserted in appropriate port cavities formed, for example, in one or both of the relay valve 102 and the PMV units 104. The sealed fluid connection is achieved by simply pressing the cartridge fitting into the port cavity. An O-ring 120 or other type of seal may be placed on the cartridge fittings 130.

FIG. 2b shows a different embodiment of the connector cartridge 106′, in which only one end is provided with a cartridge fitting 132, while the other end has a conventional fitting 134, for example incorporating threads 136. In this exemplary embodiment, the flow passage 126′ extends from the conventional fitting 134 to the cartridge fitting 132. At least a portion of the body of the connector cartridge 106′ may be shaped to facilitate tightening of the threads 163, for example by providing wrench surfaces 138.

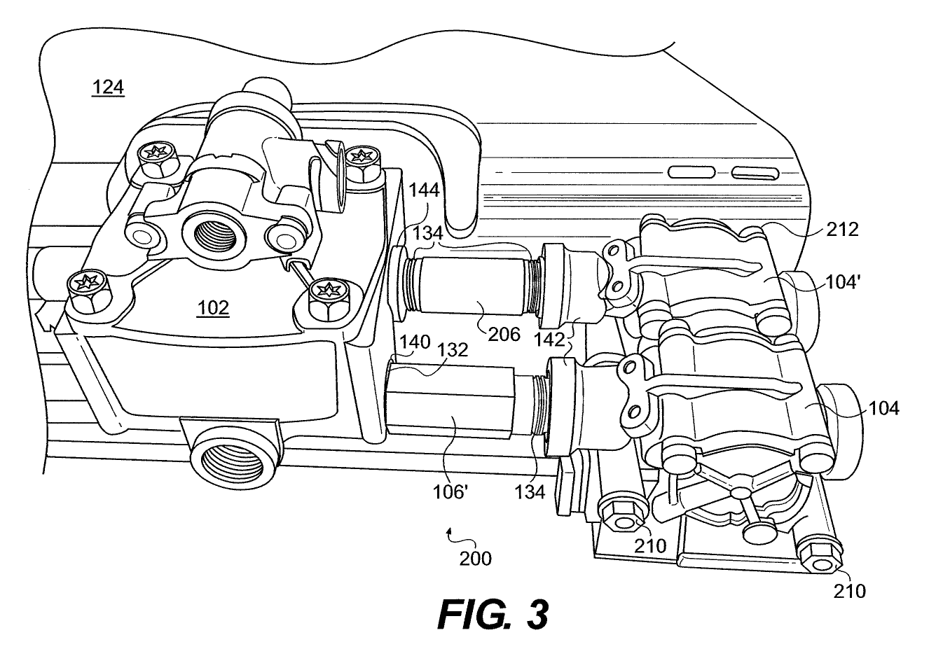

Another embodiment of an ABS rear axle assembly is shown in FIG. 3. In this embodiment, the relay valve 102 is connected to four PMV modules, of which two are shown (104, 104′). The PMV module 104′ is connected to the relay valve 102 by a cartridge connector 206, which has conventional fittings 134 at both ends. Thus, to form the fluid connection, the connector cartridge 206 is fastened, for example, to the relay 102, and then the PMV 104′ is fastened to the other end of the connector cartridge, in this case by rotating it thereon. This is possible because there is at this point sufficient clearance around the components to permit tightening of the threaded fasteners. Because of the threaded fittings, the two components are mechanically held together, so that no additional fasteners are necessary to maintain the mechanical and fluid connections between the PMV module 104′ and the relay valve 102.

PMV module 104 is connected to the relay 102 by a connector cartridge 106′, having a conventional fitting 134 and a cartridge fitting 132. For example, the conventional fitting 134 is fastened by rotation to the PMV 104, and then the two combined components can be attached, in a non-rotational manner, to the relay valve 102. This can be accomplished by simply pushing the cartridge fitting 132 into the port cavity 140. Because of the proximity of the PMV 104′, rotating PMV 104 to tighten the connection is not possible.

In a preferred exemplary embodiment of the invention, the cartridge fittings 130, 132 are designed so that they are not mechanically retained within the port cavity 140, and can be easily removed therefrom. This feature is useful to simplify replacement of defective units without damaging the rest of the device. However, other embodiments may be devised which include barbs, friction elements or other devices to more permanently retain the fittings in the corresponding port cavities.

Because the exemplary connector cartridge 106′ is not securely retained in the relay 102 by the fittings, at least in a direction along the axis of the fitting, it may be necessary to provide retaining elements that can be use to prevent unintended separation of the two components. For example, through bolts 210 may be used to secure PMV 104 to the mounting plate 124, or alternatively to the PMV 104′, which is attached to the relay valve 102 by threaded fittings. To provide additional stiffness to the integrated apparatus, the connector cartridge 206, with two threaded fittings, may be placed at a location further away from the mounting plate 124 than the connector cartridge 106′. By using the retaining element, it is not necessary to use additional fasteners to secure the PMV 104 to the relay valve 102, while still maintaining the sealed fluid connection therebetween.

In a different embodiment, a retaining strap, plate or other conventional mechanical device may be used to fasten the assembly of the PMV 104 and the connector cartridge 106′ to either or both of the mounting plate 124 and the PMV 104′. This additional structure may be necessary to prevent cartridge fitting 132 from disengaging from the port cavity 140 of the relay valve 102.

Those of skill in the art will understand that different configurations of the components may be used, in addition to those described above. For example, the requirements of a particular installation may determine whether all or some of the connection cartridges include at least one cartridge fitting according to the invention. Also, whether one or both ends of a particular connector cartridge include the cartridge fitting may depend on the application.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rear axle brake assembly, comprising:
a relay valve for controlling rear axle brakes of a vehicle;
a pressure modulator valve operatively connected to the relay valve, having an outlet fluidly connectable to one of the rear axle brakes;
a connector cartridge having a body defining a fluid passage, for sealingly connecting the relay valve and the pressure modulator valve, the connector cartridge having a first end defining a non-rotation-dependent fitting cooperating with a corresponding port cavity to form the sealed connection, and a second end defining one of a threaded fitting and another non-rotation-dependent fitting; and
a sealing element of the connector cartridge disposed on the cartridge fitting.

2. The rear axle brake assembly according to claim 1, further comprising a mounting bracket for securing the relay valve and the pressure modulator valve to the rear axle.

3. The rear axle brake assembly according to claim 1, further comprising four pressure modulator valves in fluid connection with the relay valve.

4. The rear axle brake assembly according to claim 1, wherein the relay valve is a anti lock traction relay valve.

5. The rear axle brake assembly according to claim 1, wherein the second end of the connector cartridge comprises a cartridge fitting insertable in another port cavity to form a sealed connection.

6. The rear axle brake assembly according to claim 1, wherein the connector cartridge forms a non rotation-dependent connection with at least one of the relay valve and the pressure modulator valve.

7. The rear axle brake assembly according to claim 1, wherein the pressure modulator valve and an adjacent second pressure modulator valve are disposed in such proximity as to preclude rotation of a connector of the second pressure modulator valve to sealingly connect with the relay valve.

8. The rear axle brake assembly according to claim 1, wherein the sealing element comprises an O-ring.

9. The rear axle brake assembly according to claim 5, further comprising O-ring seals disposed at the ends of the connector cartridge.

10. The rear axle brake assembly according to claim 3, wherein the four pressure modulator valves are each connected to one of four rear wheels.

11. The rear axle brake assembly according to claim 1, further comprising a retaining element to oppose unintended removal of the connector cartridge from the port cavity.

12. An anti lock braking system, comprising:
a front axle brake assembly;
a rear axle brake assembly having a rear brake for each rear wheel;
a relay valve for controlling rear axle brakes;
a plurality of pressure modulator valves operatively connected to the relay valve, each having an outlet connected to one of the rear brakes;
connector cartridges for sealingly connecting the relay valve and at least one of the pressure modulator valves, the connector cartridges having a first end defining a non rotation-dependent fitting cooperating with a corresponding port cavity to form the sealed connection, and a second end defining one of a threaded fitting and another non-rotation-dependent fitting; and
a sealing element of the connector cartridges disposed on the non rotation-dependent fitting.

13. The anti lock braking system according to claim 12, wherein the second end of the connector cartridges defines a cartridge fitting insertable in a port cavity to form a second sealed connection.

14. The anti lock braking system according to claim 12, wherein the relay valve is a traction control relay valve.

15. The anti lock braking system according to claim 12, wherein the non rotation-dependent fitting is a cartridge fitting.

16. The anti lock braking system according to claim 12, further comprising pairs of adjacent pressure modulator valves operatively connected to the relay valve.

17. The anti lock braking system according to claim 12, wherein the relay valve comprises at least two port cavities to form connections with pairs of adjacent pressure modulator valves.

18. The anti lock braking system according to claim 12, wherein at least one of the connector cartridges comprises an elongated body having a cartridge fitting on at least one end.

19. The anti lock braking system according to claim 12, further comprising a retaining element for retaining the non-rotation-dependent fitting sealingly connected in the port cavity.

20. A method of connecting brake system components, comprising the acts of:
connecting one of a relay valve and a first pressure modulator valve to a connector cartridge using a non-rotation-dependent fitting at a first end of the connector cartridge;
connecting a second end of the connector cartridge to the other of the relay valve and the pressure modulator valve using one of a threaded and a non-rotation-dependent fitting; and
repeating the connecting act between the relay valve and a second pressure modulator valve adjacent to the first pressure modulator valve.

21. The method according to claim 20, further comprising the act of connecting the first end of the connector cartridge by pushing a cartridge fitting into a corresponding port cavity.

22. The method according to claim 20, further comprising the act of connecting the second end of the connector cartridge by pushing a cartridge fitting into a corresponding port cavity.

23. The method according to claim 20, further comprising the preliminary act of:
connecting one of the relay valve and a conventional first pressure modulator valve to a conventional connector cartridge using a threaded fitting at a first end of the conventional connector cartridge; and
connecting a second end of the conventional connector cartridge to the other of the relay valve and the conventional pressure modulator valve using a threaded fitting.

24. The method according to claim 20, further comprising connecting the second end of the connector cartridge to the other of the relay valve and the pressure modulator valve using a threaded fitting.

25. A brake system assembly for a vehicle, comprising:
a relay valve for controlling rear axle brakes of the vehicle, the relay valve having at least two adjacent outlets for forming fluid connections;
pressure modulator valves operatively connected to the corresponding adjacent outlets of the relay valve;
a first connector cartridge forming a fluid passage, having first and second ends respectively forming threaded fluid connections with the relay valve and one of the pressure modulator valves; and
an additional connector cartridge forming a fluid passage, having a first end defining a cartridge fitting insertable in a port cavity of one of the relay valve outlets and of the pressure modulator valves.

26. The brake system assembly according to claim 25, further comprising a second end of the additional connector cartridge defining a cartridge fitting insertable in a corresponding port cavity.

27. The brake system assembly according to claim 25, further comprising a second end of the additional connector cartridge defining a threaded fitting.

28. The brake system assembly according to claim 25, further comprising a retaining element connecting the adjacent pressure modulator valves to oppose unintended removal thereof from the relay valve.
